(19) United States
(12) Patent Application Publication
(10) Pub. No.: US 2012/0271765 A1
(43) Pub. Date: Oct. 25, 2012

(54) ROUTING OPTIMIZATION

(76) Inventors: Karen Cervenka, Belmont, CA (US); Marla Bischoff, Menlo Park, CA (US); Manish Nath Pathak, Los Gatos, CA (US); Claudia Richter, San Francisco, CA (US)

(21) Appl. No.: 13/451,437

(22) Filed: Apr. 19, 2012

Related U.S. Application Data
(60) Provisional application No. 61/477,334, filed on Apr. 20, 2011.

(51) Int. Cl. G06Q 20/40; G06Q 20/10; G06Q 20/30

(52) U.S. Cl. 705/44

(57) ABSTRACT

A system and method are disclosed for routing optimization. A gateway processing service receives a first ordered list of payment processing networks associated with a first condition. The first ordered list comprises a higher priority payment processing network and a lower priority payment processing network. A second ordered list received by the gateway processing service comprises a higher priority payment processing network and a lower priority payment processing network. An authorization request message for a transaction is received by the gateway processing service. If the first condition is satisfied, the gateway processing service routes the authorization request message according to the first ordered list. If the first condition is not satisfied, the gateway processing service routes the authorization request message according to the second ordered list.

### CROSS-REFERENCES TO RELATED APPLICATIONS

The present application is a non-provisional application of and claims priority to U.S. Provisional Application No. 61/477,334, filed Apr. 20, 2011, the entire contents of which are herein incorporated by reference for all purposes.

### BACKGROUND

Merchants are increasingly able to choose between many options when choosing a payment processing network as a destination for routing a transaction. However, merchants lack the ability to establish preferences for routing transactions under changing conditions. As a result, transactions are often routed in a manner that is not cost effective. Further, transaction routing may not take advantage of services provided by various payment processing networks

Embodiments of the invention address these and other problems, individually and collectively.

### BRIEF SUMMARY

Techniques for optimizing routing of a transaction message are provided.

One embodiment of the technology is directed to a method for routing an authorization request message. The method includes receiving, by a gateway processing service, a first ordered list of payment processing networks associated with a first condition. The first ordered list comprises a higher priority payment processing network and a lower priority payment processing network. A second ordered list received by the gateway processing service comprises a higher priority payment processing network and a lower priority payment processing network. An authorization request message for a transaction is received by the gateway processing service. If the first condition is satisfied, the gateway processing service routes the authorization request message according to the first ordered list. If the first condition is not satisfied, the gateway processing service routes the authorization request message according to the second ordered list.

According to another embodiment of the technology, a list of payment processing networks is received by a gateway processing service. An authorization request message for a transaction is received by the gateway processing service. A volume of transactions processed via each payment processing network of the list of payment processing networks over a period of time is determined. Based on the volume of transactions processed, the processing cost for processing the transaction via each payment processing network of the list of payment processing networks is determined. The gateway processing service generates an ordered list of payment processing networks that are prioritized according to processing cost. The authorization request message is routed according to the ordered list.

A further embodiment of the technology is directed to a system for routing an authorization request message. The system comprises a processor and a computer readable medium coupled to the processor. The computer readable medium comprises code executable by the processor for implementing a method of processing transactions.

These and other embodiments are described in further detail below.

### BRIEF DESCRIPTION OF THE DRAWINGS

FIG. 1 is an illustrative block diagram of a routing optimization system.

FIG. 2 is an illustrative block diagram of a system for generating routing priority lists.

FIGS. 3A-3B depict illustrative routing priority lists.

FIG. 4 is an illustrative flow diagram showing operations involved in routing optimization.

FIG. 5 is an illustrative flow diagram showing operations involved in least cost routing.

FIG. 6 is a block diagram of an exemplary computer apparatus.

### DETAILED DESCRIPTION

Embodiments of the present invention are directed to systems and methods for routing transactions using routing priority lists having associated conditions.

Prior to discussing the specific embodiments of the technology, a further description of some terms is provided for a better understanding of embodiments of the invention.

An “authorization request message” may be a message that includes a payment account identifier. The payment account identifier may be a portable consumer device account identifier associated with a portable consumer device. The authorization request message may request that an issuer of the portable consumer device authorize a transaction. The authorization request message may include an approval code indicating approval of an authorization request.

The authorization request message may have a defined format to allow requests and responses between points in a financial network. An authorization request message according to an embodiment of the invention may be a standardized interchange message such as a message that complies with International Organization for Standardisation (ISO) 8583, which is a standard for systems that exchange electronic transactions made by cardholders using payment cards, or other electronic data interchange formats. An ISO 8583 message includes a message type indicator, one or more bitmaps indicating which data elements are present in the message, and data elements of the message. The data included in the authorization request message may include data obtained from a payment device as well as other data related to the transaction, the payment account holder, the merchant, and processing information, such as one or more of a payment account number, a payment device expiration date, a currency code, a transaction amount, a merchant transaction stamp, the acceptor city, the acceptor state/country, a routing transit number, a terminal identification, a network identification, etc. An authorization request message may be protected using a secure encryption method (e.g., 128-bit SSL or equivalent) in order to prevent data from being compromised.

A “payment device” may refer to a device used to initiate a transaction, such as a portable consumer device or a portable communication device. The payment device may interface with an access device such as a point of sale device to initiate the transaction. Typically, a portable consumer device is hand-held and compact so that it can fit into a consumer's wallet or pocket (e.g., pocket sized). Specific examples of portable consumer devices include payment cards such as smartcards, debit devices (e.g., a debit card), credit devices (e.g., a credit card), or stored value devices (e.g., a stored value card or “prepaid” card). A portable communication device, also referred to as a “mobile device,” may be, for example, a cellular or wireless telephone (e.g., a smartphone), personal digital assistant (PDA), portable computer (e.g., tablet or laptop computer), pager, or other portable device carried by the payment account holder.

An “access device” may refer to a device that receives information from a payment device to initiate a transaction. For example, an access device may be a point of sale device configured to read account data encoded in a magnetic stripe or chip of a card-format portable consumer device. Other examples of access devices include cellular phones, PDAs, personal computers, tablets, handheld specialized readers, set-top boxes, electronic cash registers, automated teller machines (ATMs), virtual cash registers, kiosks, security systems, access systems, and the like. Access devices may use means such as radio frequency (RF) and magnetic stripe readers to interact with a payment device. The access device may be a device located at a merchant's physical location or may be a virtual point of sale such as a web-site that is part of an eCommerce (electronic commerce) transaction. In an eCommerce transaction, the account owner may enter payment account data into a portable communication device, personal computer, or other device capable of communicating with a merchant computer. In a further example, communication may occur between a contactless element of a portable communication device and an access device, such as a merchant device reader or point of sale terminal, by using a wireless communications mechanism, such as near field communications (NFC), RF, infra-red, optical communications, etc.

A “gateway processing service” may refer to a service that enables transaction processing via multiple payment processing networks through a single connection to the gateway processing service. The gateway processing service may include one or more servers, data processing subsystems, networks, and operations used to deliver authorization services, exception file services, and clearing and settlement services. An authorization request message received by the gateway processing service may be routed to one of a plurality of payment processing networks according to a routing priority list. The gateway processing service may assess network connectivity of payment processing networks and may use this information in the routing of authorization request messages.

A “payment processing network” may refer to a system that receives accumulated transaction information from the gateway processing service, typically at a fixed time each day, and performs a settlement process. Settlement may involve posting the transactions to the accounts associated with the payment devices used for the transactions and calculating the net debit or credit position of each user of the payment devices. An exemplary payment processing network is Interlink®.

A “routing priority list,” also referred to as an “ordered list,” is a ranked list of payment processing networks. One or more routing priority lists may be generated by a merchant and communicated from a merchant to a gateway processing service. Alternatively, routing priority lists may be generated according to one or more criteria, such as the price charged by a network for routing the transaction via the network. Each member of the routing priority list is a payment processing network having an associated order. The routing priority list includes at least a highest priority payment processing network and a lower priority payment processing network. A routing priority list may have an associated condition. The routing priority list is applied when the condition is met.

A “condition” may be a value such as transaction amount, transaction type, the time of day at which settlement for a payment processing network occurs, merchant category code (MCC), merchant verification value (MVV), whether a payment processing network is subject to regulation, etc.

A “transaction amount” may be the price assessed to the consumer for the transaction. The transaction amount condition may be a threshold value (e.g., all transactions for an amount exceeding $100) or a range (e.g., all transactions in the range of $25-$50). For example, a user may wish to use a first routing priority list for a transaction for an amount in the range of $0.01-$100 and a second routing priority list for a transaction for an amount exceeding $100.

The “time of day” may be a cut-off time for settlement. For example, a user may wish to use a first routing priority list during a first time range and a second routing priority list during a second time range such that a payment processing network to which a transaction is routed has a cut off time that occurs within a particular period of time after the transaction occurs.

A “merchant category code” (MCC) may refer to a numerical indication of a type of business classified according to the goods or services the business provides, such as “supermarket,” “quick service restaurant,” or “fuel dispenser.” Different rates may be charged by a payment processing network depending on the MCC generating the transaction. A user may generate transactions having different associated MCC values and may wish to generate different routing priority lists for each MCC. A merchant verification value (MVV) may be a customizable value, such as a numerical indication of a region or a particular store.

A user may wish to develop a routing priority list based on “regulatory information.” A payment processing network may not be subject to a regulatory cap on the interchange fee because the payment processing network is a credit union or is otherwise exempt from the limit. In an illustrative example, a routing prioritization list is designed to avoid or to give a low priority to a payment processing network that is not subject to a regulatory fee limit.

A payment processing network that is “providing degraded service” satisfies one or more system degradation criteria. System degradation criteria include any condition resulting in delayed processing of an authorization request message by a payment processing network. System degradation criteria may also include failure of a payment processing network to process an authorization request message.

A “server computer” can be a powerful computer or a cluster of computers. For example, the server computer can be a large mainframe, a minicomputer cluster, or a group of servers functioning as a unit. In one example, the server computer may be a database server coupled to a Web server.

### Routing Optimization Overview

With the evolving regulatory climate, merchants can benefit from services to enable complex and dynamic routing prioritization at the gateway processor. The routing optimization technology disclosed herein enables merchants to establish routing priorities and utilize least cost routing for transactions.

A gateway processing service allows a merchant to route transactions to multiple payment processing networks via a single gateway processor. The merchant may establish a routing priority for payment processing networks. For example, a merchant may wish to prioritize a payment processing network offering a low interchange rate. However, if that payment processing network is unavailable, the merchant may define an alternative payment processing network to use.

Currently, a merchant may indicate a prioritized list of payment processing networks by including a representation of the list in an authorization request message. If no indication of a routing priority list is present in the authorization request message, the gateway processing service may use a prioritized list of payment processing networks provided by the merchant to the debit processing network. For example, the merchant may submit a form including a routing priority list to the gateway processing service as part of the process of establishing a connection to the gateway processing service. If the merchant has not provided a routing priority list, the debit processing service may use a default routing priority list.

If a merchant establishing routing priorities is limited to a single prioritized list, the merchant lacks the ability to establish different routing priorities to be applied in different situations. Additionally, if a merchant wishes to change the routing priorities, the merchant must either include a prioritized list in each authorization request message or fill out a new form indicating routing priorities to be stored by the debit processing network. A merchant determining routing priorities may be overwhelmed by the number of payment processing networks offering different interchange rates, incentive programs, and services. A tool to help users to understand the benefits of various routing scenarios and generate corresponding routing priority lists would be beneficial to merchants, acquirers and processors having multiple routing options.

In some cases, a payment processing network is unavailable or is failing to process transactions in a timely manner. Routing transactions to a network that is available but producing a high number of declines or timeouts can lead to substantial costs for a gateway processing service. For example, an authorization request message may be sent repeatedly due to a network timeout, resulting in multiple charges associated with the same transaction. Resolving issues related to degraded network service can be labor intensive, especially when many errors occur over a long period of time. It is desirable to have a transaction routing system capable of bypassing networks exhibiting signs of degraded service.

### Pricing Analysis Tool

A merchant considering debit transaction routing options for debit transactions may have difficulty navigating the fees charged by various payment processing networks. A debit card transaction fee may include a base transaction fee in addition to an interchange rate. The interchange rate varies across networks. Interchange rates available for processing debit transactions currently number in the thousands. Multiple interchange rates may be available for a single payment processing network depending on the merchant category code (MCC) of the merchant with which the transaction is performed. Filtering the payment processing networks displayed to a merchant according to the merchant's operations and goals allows the merchant to establish routing priorities with increased efficiency.

A merchant may wish to prioritize payment processing networks according to one or more factors such as cost, availability, reliability, or geographic location. For example, a merchant may wish to establish a routing priority based on the cost of processing a transaction on each network, assigning the highest priority to the least cost network of a routing priority list. Another basis for prioritizing a payment processing network may be the services provided by the network. For example, a payment processing network that has a lower rate of chargebacks (return of funds to the consumer from the merchant) may be preferred by a merchant to a payment processing network offering a lower processing fee but more prone to chargebacks. Similarly, a payment processing network may provide other services, such as fraud detection or alerts, that a merchant may take into account when establishing routing priorities. An incentive offered by a payment processing network, such as a rebate or volume discount, may also be a factor in routing prioritization. The merchant may also wish to prioritize payment processing networks according to the geographic locations in which the payment processing networks operate.

A pricing analysis tool is an application that may include one or more modules including a pricing analysis module, a user interface, etc. The pricing analysis tool may be used by a merchant, acquirer or processor to generate routing priority lists. It will be understood that where reference is made to a merchant, any entity having an interest in generating routing priority lists, such as an acquirer or processor, may use the pricing analysis module as described herein. The user may enter information into the user interface such as information about the merchant type, transaction volume information, historical use of payment processing networks, and information pertaining to routing preferences as described herein. The pricing analysis module may analyze the input and present the user with various hypothetical routing priority lists. For example, the pricing analysis module may generate a range of routing priority lists representing “high cost-low value” and “low cost-high value” scenarios.

The pricing analysis module may be used to associate various conditions with each routing priority list. For example, the user may wish to apply a first routing priority list when a first condition is met and a second routing priority list when the first condition is not met.

A user may input preferences related to one or more of the incentives, services, and conditions discussed above. The pricing analysis module may generate hypothetical routing priority lists based on the input. The user may select one or more routing priority lists generated by the pricing analysis module. Additionally, the user may develop one or more routing priority lists by selecting individual payment processing networks, assigning a ranking to each payment processing network in each routing priority list, and optionally associating one or more conditions with each routing priority list. The routing priority lists are transmitted by the pricing analysis module application to a gateway processing service. The routing priority lists may be stored on a server of the gateway processing service. When the user wishes to replace one or more routing priority lists, the user may generate new lists using the pricing analysis module for transmission to a gateway processing computer. In this manner, a user may rapidly change the routing priority lists applied to transactions as frequently as the user desires.

### Least Cost Routing

A least cost routing calculator may be used to optimize routing. This tool may allow merchants, processors, and acquirers to calculate the cost of routing transactions to different payment processing networks (e.g., PIN debit networks). The tool may allow users to enter specific information about their business or merchants and receive a list of pass-through transactions costs, including both fees and charges. The variables that may be considered include, but are not limited to, annual volume, average ticket size, MCC or Standard Industrial Classification (SIC) code, pre-authorization transaction count, pre-completion transaction count, average cash back amount, special pricing granted by networks (since these rates may be considered in the analysis and in the results), etc. After the analysis is performed, a list of networks and their associated prices, sorted in ascending order of the sum of the fees and charges may be displayed or applied.

For example, a payment processing network may offer a discounted processing fee based on the volume of transactions a merchant has processed with the network. A reduced interchange rate is available to the merchant when the merchant routes a number of transactions in excess of a threshold number of transactions over a fixed period of time. Accordingly, the least cost network for processing a transaction changes over time based on the relative volume of transactions processed via different payment processing networks. The fixed period of time may be, for example, a month or a quarter. In an illustrative example, Network A reduces the interchange rate it charges to Merchant A from $0.10 per transaction to $0.075 per transaction when Merchant A has processed more than two million transactions via Network A in a month.

An authorization request may be routed according to an incentive having a condition such as a minimum volume of transactions that must be met before a volume discount applies to each transaction. In one embodiment, a service such as the gateway processing service logs the number of authorization request messages originating from a merchant. The gateway processing service may determine a transaction volume over a particular period of time, such as a month-to-date transaction volume. The volume determined may be a volume of transactions routed to one or more payment processing networks offering an incentive. If a transaction volume exceeds a threshold volume associated with an incentive offered by a payment processing network, the authorization request may be routed via the payment processing network offering the incentive. If the transaction volume does not exceed the threshold volume, the request may be routed via a different payment processing network. A routing priority list may have an associated condition that a volume of transactions routed via a payment processing network exceed a threshold to meet an incentive for the payment processing network.

In some embodiments, if a transaction volume exceeds a threshold volume associated with an incentive offered by a payment processing network, the priority of the network in a routing priority list is adjusted. For example, the gateway processing service may adjust the priority of the payment processing network offering the incentive such that it is the highest priority network when the condition of the incentive is met. If a routing priority list is arranged according to interchange fee, the gateway processing service may adjust the priority of the payment processing network such that it is ranked according to processing cost taking any incentives into account. In this way, a routing priority list of payment processing networks prioritized according to processing cost is generated.

### Routing Optimization Service

Routing optimization may enable merchants, acquirers, and processors to be able to establish and maintain multiple routing priority lists and associated sets of conditions within a gateway processing service. The gateway processing service would then use routing priority lists to determine where to route transactions. These lists could be established based on the results of data from a pricing analysis module or other tools.

A routing optimization service may refer to one or more applications for storing and applying routing priority lists generated by merchants, acquirers and processors. The routing optimization service is typically implemented as a component of a gateway processing service.

The gateway processing service may include a routing optimization module executed by a gateway processor computer. The routing optimization module receives one or more routing priority lists. For example, the routing priority lists may be transmitted to the gateway processor computer by a pricing analysis module as described above. Alternatively, a merchant may submit one or more routing priority lists to the gateway processing service electronically, such as by way of a network connection between a merchant computer and a computer associated with the gateway processing service. Routing priority lists received from a plurality of merchants are stored in memory of a computer associated with the gateway processing service. For example, the routing priority lists may be stored in a database communicatively coupled to a gateway processor computer.

An authorization request message received by the gateway processor computer from a merchant is routed according to one or more routing priority lists received from the merchant. If the gateway processor computer has received multiple routing priority lists from a merchant, including at least one routing priority list having an associated condition, the routing optimization module applies the condition to determine which of the multiple routing priority lists to apply when processing the transaction.

The routing optimization module applies one or more criteria to determine whether the highest priority payment processing network on a routing priority list will be the routing destination for an authorization request message. For example, the routing optimization module may determine if the highest priority payment processing network supports the payment device used for the transaction. In another example, the routing optimization module may determine whether the highest priority payment processing network is bypassed. A payment processing network may be temporarily bypassed if it is unavailable (i.e., unresponsive) or if the network is providing degraded service. If the criteria applied by the routing optimization module are met, the routing optimization module determines that the transaction is to be routed via the highest priority payment processing network. If the criteria are not met, the routing optimization module may apply the criteria to the second highest rated payment processing network. If the criteria applied to the second highest rated payment processing network are met, the transaction is routed via the second highest rated payment processing network. If not, the routing optimization module may apply the criteria to the third highest payment processing network, and so on.

### Enhanced Dynamic Routing

In some cases, payment processing networks may experience service degradation that results in higher authorization declines, timeouts, etc. for merchants, acquirers, and processors. Dynamic routing may enhance the gateway processing service dynamic routing functionality by expanding the criteria used to determine when to temporarily remove a network from the list of available payment processing networks available for routing (e.g., debit routing). In some instances, a payment processing network may only invoke dynamic routing when a network is hard down or has been manually marked as providing degraded service. The dynamic routing solution disclosed herein may use system degradation criteria such as an unusual number of declines to determine whether to route a transaction to a payment processing network. This enhancement may increase the sensitivity of the existing routing criteria.

The gateway processing service may monitor network availability based upon pre-defined service quality criteria and temporarily remove any payment processing network from the list of payment processing networks available for routing. The enhancement may also provide internal reports to facilitate network service quality monitoring and adjustments of trigger thresholds.

A gateway processing service may apply system degradation criteria to determine that a payment processing network is to be temporarily bypassed in transaction routing. When an authorization request message is routed to a payment processing network, the authorization request message may not be processed due to occurrence of an error such as a decline, a timeout, an encryption error, etc. Each time an authorization request message is routed to a payment processing network, a record of whether the authorization request message was processed or an error was produced is stored by the gateway processing service. Evaluation of system degradation criteria may involve analyzing the records to determine a percentage of errors occurring over a particular period of time or a number of errors occurring over a particular period of time. The evaluation may be performed periodically or each time an error occurs. If the evaluation reveals that system degradation criteria are met, the payment processing network is determined to be providing degraded service. A payment processing network that is providing degraded service may be temporarily flagged or temporarily removed from a list of payment processing networks available as routing destinations for authorization request messages.

Examples of system degradation criteria include a rate of declines produced by the payment processing network in excess of a threshold rate of declines over a period of time. In an illustrative example, a threshold rate is 30% of authorization request messages declined over a period of five minutes. If the rate of declines in a five minute period exceeds the threshold rate, the payment processing network is determined to be providing degraded service. Additional examples of system degradation criteria include a number of declines produced by the payment processing network in excess of a threshold number of declines over a period of time, a number of timeouts produced by the payment processing network in excess of a threshold number of timeouts over a period of time, and a rate of timeouts produced by the payment processing network in excess of a threshold rate of timeouts over a period of time. An encryption error generated by a payment processing network may also trigger the temporary designation of the payment processing network as providing degraded service.

Parameters used to define system degradation criteria may be adjustable by one or more of the merchants, acquirers, processors, and the gateway processing service. For example, the pricing analysis module and the routing optimization module may receive input from user interface applications configured to allow adjustment of the parameters. System degradation criteria parameters such as error conditions, the period of time used in the evaluation, and the duration of time during which the payment processing network will be flagged or removed from a routing availability list may all be configurable via a user interface.

A network that is unresponsive or otherwise determined to be unavailable may also be temporarily flagged or temporarily removed from the list of available payment processing networks.

### Routing Optimization System

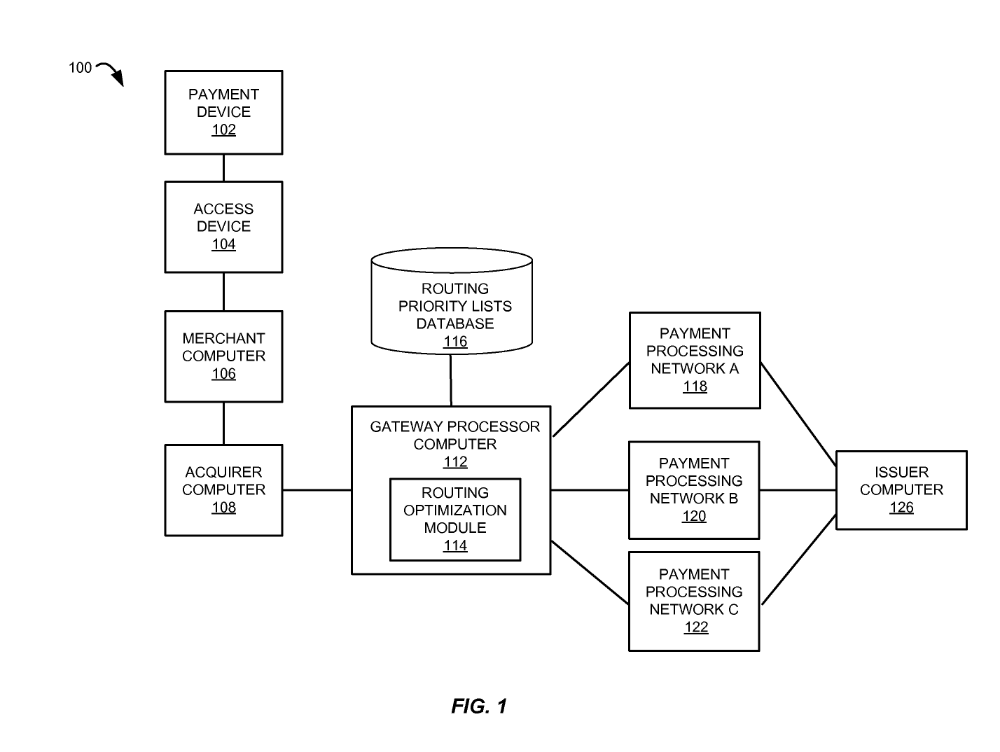

An exemplary system 100 for embodiments of the technology can be seen in FIG. 1. Where only one of each component is shown, it is understood that embodiments of the technology may include more than one of each component. In addition, some embodiments of the technology may include fewer than all of the components shown in FIG. 1. Also, the components in FIG. 1 may communicate via any suitable communication medium (including the internet), using any suitable communication protocol. The exemplary system 100 depicts an example of the system in which routing optimization may take place.

The routing optimization system 100 includes one or more server computers, data processing subsystems and networks that can be used to initiate an authorization request message for a transaction and route the authorization request message to an entity capable of approving the transaction.

In a typical payment transaction, a payment account holder provides a payment account identifier (e.g., a 16, 18 or 19 digit PAN or primary account number) or payment device identifier (e.g., a phone number) to a merchant, service provider, or other potential recipient of funds. The payment account identifier or payment device identifier may be provided by a card (e.g., a magnetic stripe card or smart card with an embedded chip) to an access device such as a point of sale terminal with a card reader. Alternatively, the payment account identifier may be provided by a contactless element embedded in a mobile device that communicates with a point of sale terminal using a wireless communications protocol. In other embodiments, the payment account identifier is stored in the memory of the mobile device, stored in a database accessible by the mobile device via wireless communications, or any other suitable form.

Typically, an electronic payment transaction is authorized if the payment account holder conducting the transaction is properly authenticated (i.e., their identity and their valid use of a payment account is verified) and has sufficient funds or credit in the payment account to satisfy the transaction. Conversely, if there are insufficient funds or credit in the account, or if the payment device is on a negative list (e.g., it is indicated as possibly having been stolen), then an electronic payment transaction may not be authorized.

In the following description, an “acquirer” is typically a business entity (e.g., a commercial bank) that has a business relationship with a particular merchant. For example, the acquirer may deposit funds into a merchant bank account and recoup those funds from issuers. An “issuer” is typically a business entity (e.g., a bank or credit union) which issues a payment device (such as a credit card, debit card, smart card, prepaid device or contactless device) to an account owner and which provides administrative and management functions for the payment account. Some entities may perform both issuer and acquirer functions. A payment account may be any account usable in a transaction, such as a credit, debit or prepaid account.

In a typical transaction, a payment device such as payment device 102 interfaces with an access device 104 (or, in some embodiments, with merchant computer 106) to initiate a transaction. After access device 104 receives the payment account identifier or the payment device identifier, access device 104 or merchant computer 106 generates an authorization request message for the transaction. As part of generating the authorization request message, merchant computer 106 may communicate with a database which stores data such as data regarding the account owner, the payment device, and the account owner's transaction history with the merchant. The merchant computer 106 (or access device 104) transmits the authorization request message to the acquirer computer 108.

An acquirer may process transactions received from the merchant. Alternatively, an acquirer may outsource the processing of transactions to a third-party processor such as a gateway processing service. A merchant computer 106 (or access device 104) may transmit an authorization request message directly to gateway processor computer 112.

Gateway processor computer 112 may be a server computer that is a component of a gateway processing service. Routing optimization module 114 is executed by gateway processor computer 112. Routing optimization module 114 accesses routing priority lists stored in routing priority lists database 116 to determine which of a plurality of payment processing networks (e.g., payment processing networks 118-122) will be the destination of an authorization request message received by gateway processor computer 112. Routing priority lists database 116 may be stored on a device that is communicatively coupled to gateway processor computer 112, such as a server computer having a network connection to gateway processor computer 112. Alternatively, routing priority lists database 116 may be stored on gateway processor computer 112.

The gateway processor computer may execute an application, such as routing optimization module 114 or another application, to parse the authorization request message to obtain information used by routing optimization module 114 to determine how to route the authorization request message. For example, a prioritized list of networks may be stored in the authorization request message. In another example, the transaction amount is obtained from the authorization request message. The routing optimization module 114 may use information such as the transaction amount to determine which routing priority list to apply to an authorization request message. In yet another example, the payment processing networks that support the payment device used for the transaction may be obtained from or determined based on information obtained from the authorization request message. The routing optimization module 114 may use information such as whether a payment processing network supports a payment device used for a transaction to determine whether to route a message to a highest priority payment processing network designated on a routing priority list. If the highest priority payment processing network is not supported, the routing optimization module determines whether a payment processing network having a lower priority is supported. In this manner, the authorization request message is routed to a payment processing network that supports the payment device used for the transaction.

It will be appreciated that more or fewer payment processing networks than exemplary “Payment Processing Network A” (118), “Payment Processing Network B” (120), and “Payment Processing Network C” (122) may be available to as a routing destination for an authorization request.

The payment processing network that receives the authorization request message transmits the authorization request message to issuer computer 126. The issuer computer 126 generates an authorization response message indicating whether the transaction was authorized. The authorization response message is routed back to the merchant computer 106. The authorization response may be displayed by the access device 104 (e.g., a POS terminal), printed on a receipt, or otherwise conveyed to the payment account holder.

A clearing and settlement process is typically conducted by each of the payment processing networks at a fixed time. The fixed time may vary from one network to another. A clearing process is a process of exchanging financial details between an acquirer and an issuer to facilitate posting to the payment account holder's account and reconciliation of the consumer's settlement position. Clearing and settlement may occur simultaneously.

Routing priority lists stored in database 116 may be created with a pricing analysis tool. The pricing analysis tool may be an application executed by merchant computer 106, acquirer computer 108, gateway processor computer 112, or another computer capable of transmitting data to the gateway processor computer 112. The pricing analysis tool is typically capable of accessing debit network pricing schedules. The tool may enable merchants, acquirers, and processors to establish multiple routing lists based upon key values that may impact their routing decisions, such as transaction amount, transaction type, time of day, MCC, MVV, regulatory status, payment processing network services and incentives, etc. To use the tool, merchants, acquirers, and processors may provide input via a user interface of the pricing analysis tool. A pricing analysis module of the pricing analysis tool may then produce one or more routing priority lists of payment processing networks based on the input provided. In this manner, a merchant, acquirer or processor may use the pricing analysis tool to identify routing options, determine routing priorities, and establish routing priority lists based on transaction characteristics and network offerings.

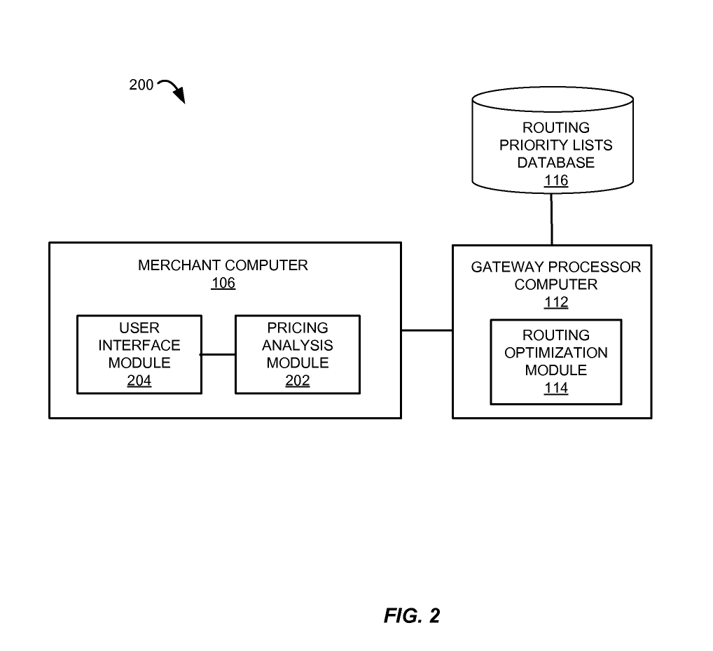

FIG. 2 shows a system 200 for generating routing priority lists. Pricing analysis module 202 may be executed by a client device used by a merchant, acquirer or processor, such as a mobile device, tablet, laptop computer, desktop computer, etc. For example, a merchant may use a pricing analysis tool application including pricing analysis module 202 executed by merchant computer 106, as shown in FIG. 2. An acquirer may use a pricing analysis tool with pricing analysis module 202 executed by acquirer computer 108. In some embodiments, the pricing analysis module is executed by gateway processor computer 112 or another server computer and accessed remotely by a client device of a merchant, acquirer or processor.

A user interface module 204 may receive user input, communicate the input to the pricing analysis module 202, and display information such as routing priority lists generated by the pricing analysis module 202 on a display of a client device such as merchant computer 106. A merchant may use the user interface module 204 to provide input related to routing priority, such as pricing preferences, services desired from payment processing networks, incentives available from payment processing networks, etc. In some embodiments, sample routing priority lists are generated based on input provided by the merchant. In other embodiments, a merchant may select payment processing networks from list of payment processing networks and assign a priority to each payment processing network. The list of payment processing networks may be filtered according to one or more of merchant input, historical data such as historical routing priority lists generated by the merchant, a determination by the pricing analysis module of payment processing networks available to the merchant, data obtained from a remote source (such as a payment processing network, a gateway processor computer, etc.), and the like. Historical data may be data that is stored by the pricing analysis module 202 or data obtained from routing priority lists database 116. The merchant may use the user interface to view current or historical routing priority lists, for example, to make adjustments to routing priorities.

In one embodiment, the parameter-based routing may be an enhancement to the single static debit network routing list maintained within the payment processing network for the PIN debit gateway service for a merchant, acquirer, or a processor. Using user interface module 204, the merchant may apply one or more conditions to each routing priority list. For example, the merchant may associate a first transaction amount range (e.g., $0.01-$100) with a first routing priority list and a transaction amount threshold (e.g., >$100) with a second routing priority list.

When the merchant is satisfied with the routing priority lists, the merchant may indicate that the routing priority lists are to be transmitted to the gateway processing computer 112. The routing priority lists are received by the gateway processing computer 112 for storage on routing priority lists database 116. In some embodiments, the routing priority lists are batch updated.

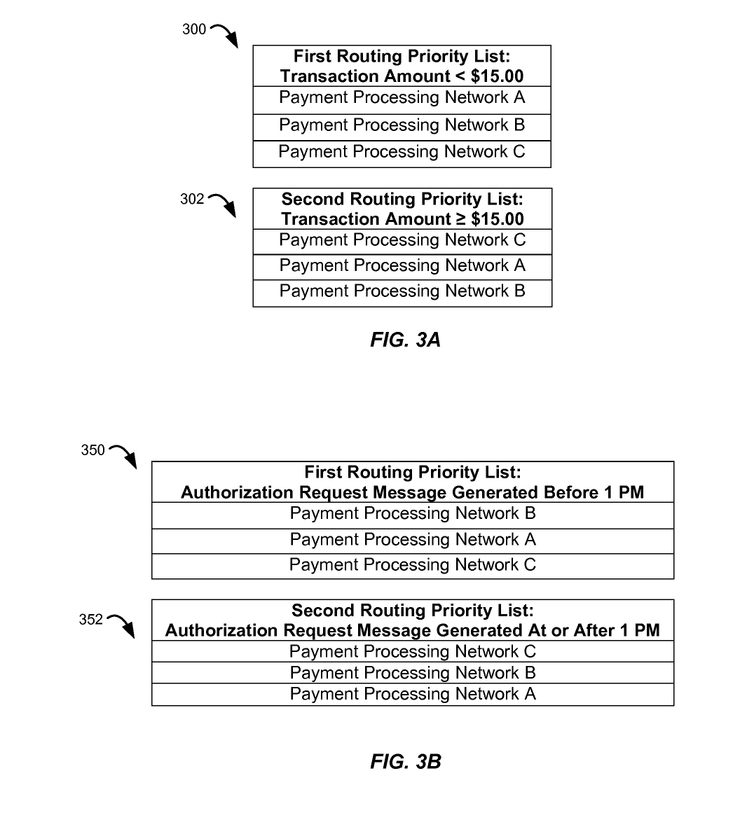

FIGS. 3A and 3B show illustrative routing priority lists. Routing priority lists include a plurality of payment processing networks. Each payment processing network has a rank within the routing priority list. For example, in FIG. 3A, a first routing priority list 300 has Payment Processing Network A, Payment Processing Network B, and Payment Processing Network C. Payment Processing Network A is the highest priority network in the routing priority list as indicated by its position at the top of the list. Payment Processing Network B has a lower priority than Payment Processing Network A, as indicated by its position below Payment Processing Network A. Payment Processing Network B has a higher priority than Payment Processing Network C, as indicated by its position above Payment Processing Network C.

In some embodiments, one or more conditions may be associated with a routing priority list. The routing priority list is applied when each of the conditions are met. The merchant may have the ability to indicate an order in which routing priority lists are applied. For example, First Routing Priority List 300 has an associated condition of “Transaction Amount<$15.00.” When an authorization request message for a transaction is received by gateway processor computer 112, routing optimization module 114 will apply First Routing Priority List 300 if the amount of the transaction is under $15.00. If the transaction amount is not less than $15.00, routing optimization module 114 will apply Second Routing Priority List 302. If a condition is associated with Second Routing Priority List 302, routing optimization module 114 will determine whether the condition is satisfied. Second Routing Priority List 302 has an associated condition of “Transaction Amount≧$15.00.” If the transaction amount is greater than or equal to $15.00, routing optimization module 114 will apply Second Routing Priority List 302. If the condition associated with a second routing priority list is not met, the routing optimization module may proceed to a third routing priority list and so on.

Other conditions for routing priority lists may include transaction type, the time of day at which settlement for a payment processing network occurs, merchant category code (MCC), merchant verification value (MVV), and whether a payment processing network is subject to regulation. FIG. 3B shows illustrative First Routing Priority List 350 having an associated condition “Authorization Request Message Generated Before 1 PM” and illustrative Second Routing Priority List 352 having an associated condition “Authorization Request Message Generated At or After 1 PM.” Exemplary Payment Processing Network B may have a daily cut-off time of 1 PM. A merchant may wish to route transactions occurring before the cut-off time to Payment Processing Network B. If the transaction occurs after the daily cut-off time, the merchant may wish to route the authorization request message for the transaction to a network with a later cut-off time.

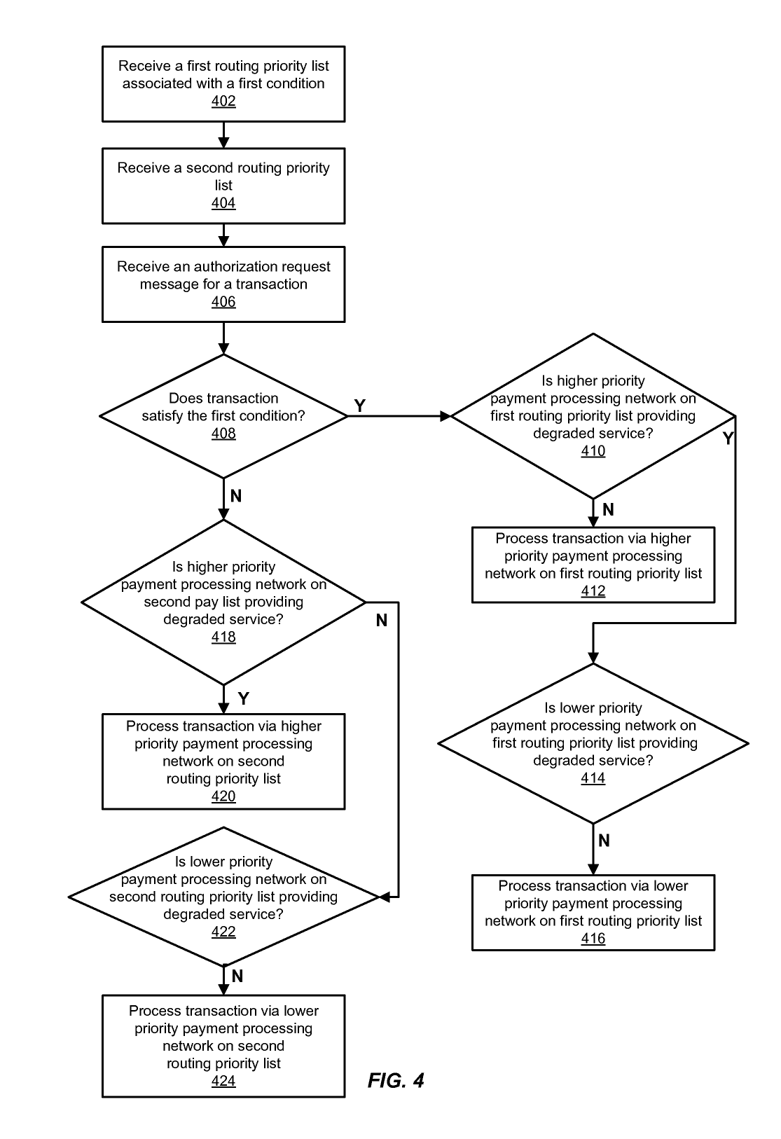

FIG. 4 is a flow diagram showing operations involved in routing optimization according to an embodiment. At operation 402, gateway processor computer 112 receives a first routing priority list having a first associated condition. For example, gateway processor computer 112 may receive a routing priority list generated by pricing analysis module 202 from merchant computer 106. Gateway processor computer 112 may store the routing priority list in routing priority lists database 116. At operation 404, gateway processor computer 112 receives a second routing priority list. At operation 406, gateway processor computer 112 receives an authorization request message for a transaction. For example, the authorization request message may be received from access device 104 (e.g., via one or more of merchant computer 106 and acquirer computer 108).

At operation 408, routing optimization module 114 determines whether the transaction satisfies the first condition. For example, a first condition may be a transaction amount range associated with the first routing priority list. If the condition is satisfied (e.g., the transaction is within the transaction amount range), routing optimization module 114 determines which payment processing network of the first routing priority list will be the routing destination for the authorization request message. In some embodiments, the authorization request message is parsed to obtain information related to the condition, such as a transaction amount. This information is received by the routing optimization module 114 so that it may apply the condition.

Routing optimization module 114 may determine whether a higher priority payment processing network on the first routing priority list is providing degraded service, as indicated at operation 410. As an example of a payment processing network providing degraded service, the payment processing network may be generating a high number of timeouts. If the higher priority payment processing network of the first routing priority list is not providing degraded service, routing optimization module 114 routes the authorization request message to the higher priority payment processing network, as indicated at operation 412. If the higher priority payment processing network on the first routing priority list is providing degraded service, routing optimization module 114 determines whether a lower priority payment processing network on the first routing priority list is providing degraded service, as indicated at operation 414. If the lower priority payment processing network on the first routing priority list is not providing degraded service, routing optimization module 114 routes the authorization request message to the lower priority payment processing network on the first routing priority list, as indicated at operation 416. The higher priority payment processing network may be a payment processing network having the highest priority on a routing priority list. The lower priority payment processing network may be a payment processing network having a second highest priority on the routing priority list.

At operation 418, routing optimization module 114 determines whether a higher priority payment processing network on the second routing priority list is providing degraded service. If the higher priority payment processing network of the second routing optimization list is not providing degraded service, routing optimization module 114 routes the authorization request message to the higher priority payment processing network, as indicated at operation 420. If the higher priority payment processing network on the second routing priority list is providing degraded service, routing optimization module 114 determines whether a lower priority payment processing network on the second routing priority list is providing degraded service, as indicated at operation 422. If the lower priority payment processing network on the second routing priority list is not providing degraded service, routing optimization module 114 routes the authorization request message to the lower priority payment processing network on the second routing priority list, as indicated at operation 424.

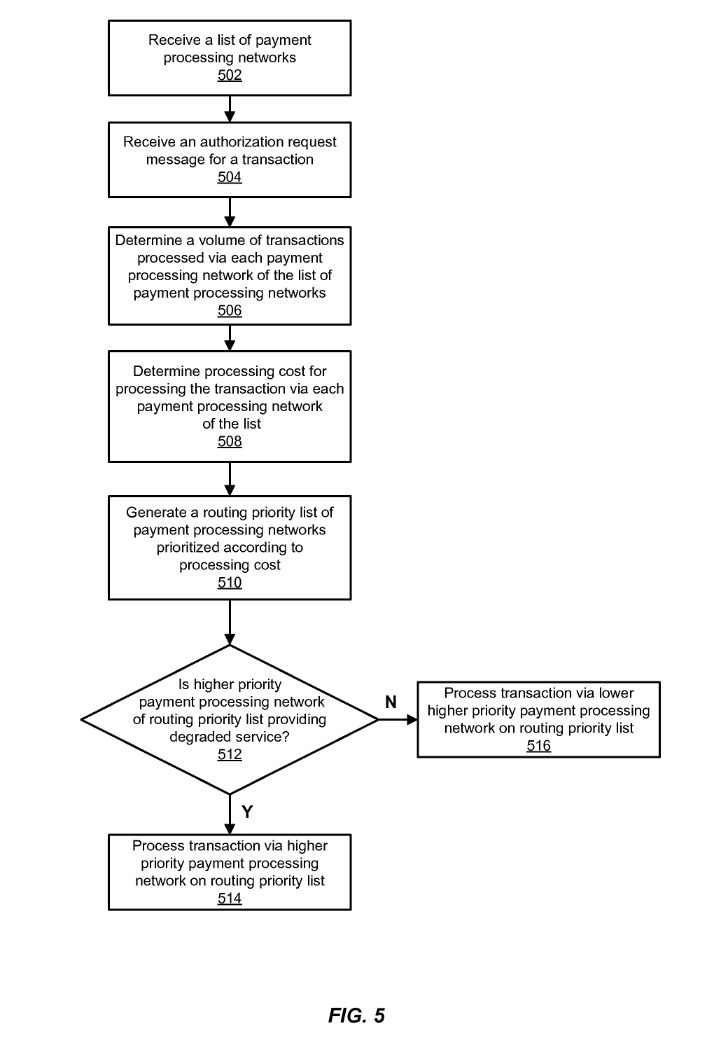

FIG. 5 is a flow diagram showing operations involved in least cost routing according to an embodiment. At operation 502, a list of payment processing networks is received by gateway processor computer 112. For example, the list may be established by merchant computer 106 and transmitted to gateway processor computer 112. At operation 504, gateway processor computer 112 receives an authorization request message for a transaction. At operation 506, a volume of transactions processed via each payment processing network of the list of payment processing networks is determined. For example, the volume of transactions processed to date in a period of time (e.g., a month) by each payment processing network of the list may be retrieved from merchant computer 106, by gateway processor computer 112, or by another computer. It will be understood that a volume of transactions may be calculated periodically and information regarding the periodically calculated volume may be accessed by the gateway processor computer 112 at operation 506. At operation 508, the processing cost for processing the transaction via each payment processing network of the list of payment processing network is determined based on the retrieved volume information. At operation 510, a routing priority list may be generated according to the processing cost associated with each network, with the highest priority assigned to the least cost network, the second highest priority assigned to the next lowest cost network, and so on. The routing priority list may be generated by routing optimization module 114 or by pricing analysis module 202, and stored by gateway processor computer 112 or merchant computer 106.

At operation 512, routing optimization module 114 determines whether the higher priority payment processing network of the routing priority list is providing degraded service. If the higher priority payment processing network is not providing degraded service, the authorization request message is routed to a higher priority payment processing network on the routing priority list, as indicated at operation 514. If the higher priority payment processing network is providing degraded service, the authorization request message is routed to a lower priority payment processing network on the routing priority list, as indicated at operation 516.

The various participants and elements described herein with reference to the figures may operate one or more computer apparatuses to facilitate the functions described herein. Any of the elements in the figures, including any servers or databases, may use any suitable number of subsystems to facilitate the functions described herein.

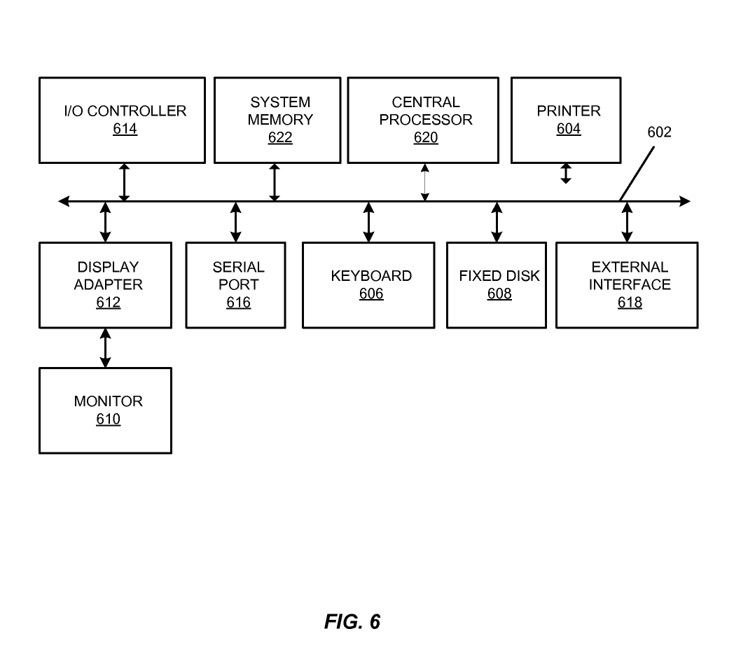

Examples of such subsystems or components are shown in FIG. 6. The subsystems shown in FIG. 6 are interconnected via a system bus 602. Additional subsystems such as a printer 604, keyboard 606, fixed disk 608 (or other memory comprising computer readable media), monitor 610, which is coupled to display adapter 482, and others are shown. Peripherals and input/output (I/O) devices, which couple to I/O controller 614 (which can be a processor or other suitable controller), can be connected to the computer system by any number of means known in the art, such as serial port 616. For example, serial port 616 or external interface 618 can be used to connect the computer apparatus to a wide area network such as the Internet, a mouse input device, or a scanner. The interconnection via system bus allows the central processor 620 to communicate with each subsystem and to control the execution of instructions from system memory 622 or the fixed disk 608, as well as the exchange of information between subsystems. The system memory 622 and/or the fixed disk 608 may embody a computer readable medium.

### Technical Benefits

There are numerous advantages provided by embodiments of the invention. First, establishing different routing priorities according to various conditions allows a merchant to take advantage of variable pricing schemes offered by payment processing networks. For example, if a payment processing network offers a lower rate for particular types of transactions exceeding a threshold amount, multiple routing priority lists enable the merchant to prioritize the payment processing network according to transaction type. Second, a pricing analysis tool provides a comparative representation of the benefits provided by different prioritization schemes, allowing merchants to efficiently determine which prioritization lists to implement. Third, a greater number of transactions will be successfully processed when a payment processing network that is providing degraded service is detected and bypassed.

Embodiments of the technology are not limited to the above-described embodiments. For example, although separate functional blocks are shown for an issuer, payment processing network, and acquirer, some entities perform all of these functions and may be included in embodiments of the technology.

Specific details regarding some of the above-described aspects are provided above. The specific details of the specific aspects may be combined in any suitable manner without departing from the spirit and scope of embodiments of the technology. For example, back end processing, data analysis, data collection, and other transactions may all be combined in some embodiments of the technology. However, other embodiments of the technology may be directed to specific embodiments relating to each individual aspect, or specific combinations of these individual aspects.

It should be understood that the present technology as described above can be implemented in the form of control logic using computer software (stored in a tangible physical medium) in a modular or integrated manner. Based on the disclosure and teachings provided herein, a person of ordinary skill in the art will know and appreciate other ways and/or methods to implement the present technology using hardware and a combination of hardware and software

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the technology will become apparent to those skilled in the art upon review of the disclosure. The scope of the technology should, therefore, be determined not with reference to the above description, but instead should be determined with reference to the pending claims along with their full scope or equivalents.

One or more features from any embodiment may be combined with one or more features of any other embodiment without departing from the scope of the technology.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method of for routing an authorization request message, comprising, by a gateway processing service:
receiving a first ordered list of payment processing networks associated with a first condition, the first ordered list comprising a higher priority payment processing network and a lower priority payment processing network;
receiving a second ordered list of payment processing networks, the second ordered list comprising a higher priority payment processing network and a lower priority payment processing network;
receiving an authorization request message for a transaction;
determining whether the first condition is satisfied;
if the first condition is satisfied, routing the authorization request message according to the first ordered list; and
if the first condition is not satisfied, routing the authorization request message according to the second ordered list.

2. The method of claim 1, wherein routing the authorization request message according to the first ordered list comprises:
determining whether the higher priority payment processing network of the first ordered list is providing degraded service;
if the higher priority payment processing network of the first ordered list is not providing degraded service, routing the authorization request message via the higher priority payment processing network of the first ordered list; and
if the higher priority payment processing network of the first ordered list is providing degraded service, routing the authorization request message via the lower priority payment processing network of the first ordered list.

3. The method of claim 2, wherein determining whether a payment processing network is providing degraded service comprises determining if the payment processing network is unavailable.

4. The method of claim 2, wherein determining whether a payment processing network is providing degraded service comprises determining if the payment processing network has generated a number of declines in excess of a threshold number of declines over a predetermined period of time.

5. The method of claim 2, wherein determining whether a payment processing network is providing degraded service comprises determining if the payment processing network has generated a number of timeouts in excess of a threshold number of timeouts over a predetermined period of time.

6. The method of claim 2, wherein determining whether a payment processing network is providing degraded service comprises determining if the payment processing network generated an encryption error.

7. The method of claim 1, wherein routing the authorization request message according to the first ordered list comprises:
determining whether a payment device used to perform the transaction is supported by the higher priority payment processing network of the first ordered list;
if the payment device is supported by the higher priority payment processing network of the first ordered list, routing the authorization request message via the higher priority payment processing network of the first ordered list; and
if the payment device is not supported by the higher priority payment processing network of the first ordered list, routing the authorization request message via the lower priority payment processing network of the first ordered list.

8. The method of claim 1, wherein routing the authorization request message according to the first routing priority list comprises:
determining whether the volume of transactions processed via the higher priority payment processing network of the first routing priority list over a predetermined period of time exceeds a threshold;
if the volume of transactions exceeds the threshold, routing the authorization request message via the higher priority payment processing network of the first routing priority list; and
if the volume of transactions does not exceed the threshold, routing the authorization request message via the lower priority payment processing network of the routing priority list.

9. The method of claim 1, wherein the first condition is selected from the group consisting of: a transaction amount range, a time of day range, a transaction type, a merchant verification value, a regulatory status, and a merchant category code.

10. The method of claim 1, wherein a second condition is associated with the second ordered list.

11. A method for routing an authorization request message, comprising, by a gateway processing service:
receiving a list of payment processing networks;
receiving an authorization request message for a transaction;
determining the volume of transactions processed via each payment processing network of the list of payment processing networks over a predetermined period of time;
determining, based on the volume of transactions processed, the processing cost for processing the transaction via each payment processing network of the list of payment processing networks;
generating an ordered list of payment processing networks prioritized according to processing cost, the ordered list comprising a higher priority payment processing network and a lower priority payment processing network; and
routing the authorization request message according to the ordered list.

12. The method of claim 11, wherein routing the authorization request message according to the ordered list comprises:
determining whether the higher priority payment processing network of the ordered list is providing degraded service;
if the higher priority payment processing network of the ordered list is not providing degraded service, routing the authorization request message via the higher priority payment processing network of the ordered list; and
if the higher priority payment processing network of the ordered list is providing degraded service, routing the authorization request message via the lower priority payment processing network of the ordered list.

13. The method of claim 12, wherein determining whether a payment processing network is providing degraded service comprises determining if the payment processing network is unavailable.

14. The method of claim 12, wherein determining whether a payment processing network is providing degraded service comprises determining if the payment processing network has generated a number of declines in excess of a threshold number of declines over a predetermined period of time.

15. The method of claim 12, wherein determining whether a payment processing network is providing degraded service comprises determining if the payment processing network has generated a number of timeouts in excess of a threshold number of timeouts over a predetermined period of time.

16. The method of claim 12, wherein determining whether a payment processing network is providing degraded service comprises determining if the payment processing network generated an encryption error.

17. The method of claim 11, wherein routing the authorization request message according to the ordered list comprises:
determining whether a payment device used to perform the transaction is supported by the highest priority payment processing network of the ordered list;
if the payment device is supported by the higher priority payment processing network of the first ordered list, routing the authorization request message via the higher priority payment processing network of the ordered list; and
if the payment device is not supported by the higher priority payment processing network of the first ordered list, routing the authorization request message via the lower priority payment processing network of the ordered list.

18. A system for routing an authorization request message, comprising:
a processor; and
a computer readable medium coupled to the processor, wherein the computer readable medium comprises code executable by the processor for implementing a method of processing transactions, the method comprising:
by a gateway processing service:
receiving a first ordered list of payment processing networks associated with a first condition, the first ordered list comprising a higher priority payment processing network and a lower priority payment processing network;
receiving a second ordered list of payment processing networks, the second ordered list comprising a higher priority payment processing network and a lower priority payment processing network;
receiving an authorization request message for a transaction;
determining whether the first condition is satisfied;
if the first condition is satisfied, routing the authorization request message according to the first ordered list; and
if the first condition is not satisfied, routing the authorization request message according to the second ordered list.

19. The system of claim 18, wherein the first condition is selected from the group consisting of: a transaction amount range, a time of day range, a transaction type, a merchant verification value, a regulatory status, and a merchant category code.

20. The system of claim 18, wherein a second condition is associated with the second ordered list
